(19) United States
(12) Patent Application Publication
(10) Pub. No.: US 2015/0009216 A1
(43) Pub. Date: Jan. 8, 2015

(54) STORAGE MEDIUM, IMAGE PROCESSING APPARATUS, IMAGE PROCESSING SYSTEM AND IMAGE PROCESSING METHOD

(71) Applicant: NINTENDO CO., LTD., Kyoto (JP)

(72) Inventor: Ken WATANABE, Kyoto (JP)

(73) Assignee: NINTENDO CO., LTD., Kyoto (JP)

(21) Appl. No.: 14/057,400

(22) Filed: Oct. 18, 2013

(30) Foreign Application Priority Data
Jul. 8, 2013 (JP) 2013-142967

(51) Int. Cl. G06T 15/60

(52) U.S. Cl. CPC G06T 15/60
USPC 345/426

(57) ABSTRACT

An information processing apparatus that functions as non-liming example image processing apparatus includes a CPU that performs an updating process of a determinant for producing a shadow map in parallel with production and display processing of image data. In the updating process of the determinant, even in a case where an imaging range of a virtual camera is changed or a direction of a light from a light source is changed, if and when a changing amount of the imaging range of the virtual camera from a time that the determinant is previously calculated (updated) is less than a predetermined amount and a changing amount of the direction of the light from the light source from that time is also less than a predetermined amount, the determinant is not updated.

### CROSS REFERENCE OF RELATED APPLICATION

The disclosure of Japanese Patent Application No. 2013-142967 filed on Jul. 8, 2013 is incorporated herein by reference.

### FIELD

This application describes a storage medium, an image processing apparatus, an image processing system and an image processing method, producing an image viewing a virtual space from a viewpoint.

### SUMMARY

A primary object of the present embodiment is to provide a novel storage medium, image processing apparatus, image processing system and image processing method.

Another object of the embodiment is to provide a storage medium, image processing apparatus, image processing system and image processing method, capable of reducing a flicker of a screen at an edge portion of a shadow as much as possible.

A first embodiment is a non-transitory storage medium storing an image processing program that is executable by a computer, the image processing program causing the computer to function as a calculating portion, a producing portion and a depicting portion. The calculating portion repeatedly calculates a determinant for producing a shadow map. The producing portion produces a shadow map by using the determinant calculated by the calculating portion. The depicting portion depicts an image that is viewed from a virtual camera by utilizing the shadow map produced by the producing portion. In addition, the calculating portion does not calculate (update) the determinant, if and when a changing amount of an imaging range of the virtual camera is less than a first predetermined amount.

According to the first embodiment, since the determinant for producing a shadow map is not updated in a case where a changing amount of the imaging range of the virtual camera is less than the first predetermined amount, a phenomenon that a shape of an edge portion of a shadow is subtly changed does not occur. Therefore, it is possible to reduce as much as possible a flicker of a screen at the edge portion of the shadow.

A second embodiment is according to the first embodiment, wherein the changing amount of the imaging range is a cumulative changing amount after the determinant is previously calculated by the calculating portion. That is, if and when the cumulative changing amount of the imaging range after the determinant is updated previously is less than the first predetermined amount, the determinant is not updated. In addition, if and when the cumulative changing amount is equal to or more than the first predetermined amount, the determinant is updated.

According to the second embodiment, since it is decided whether the determinant is to be updated based on whether the cumulative changing amount of the imaging range from a time that the determinant is previously updated is less than the first predetermined amount, it is possible to avoid a disadvantage that the determinant is not updated even though the imaging range is largely changed from a time that the determinant is previously updated by changing the imaging range by an amount less than the first predetermined amount.

A third embodiment is according to the first embodiment, wherein the shadow map is produced for a range that is wider than the imaging range.

According to the third embodiment, it is possible to meet a change of the imaging range even in a case where the determinant is not updated.

A fourth embodiment is according to the first embodiment, wherein the imaging range is changed by changing at least one of a position, direction and angle of view of the virtual camera. In addition, even if and when at least one of the position, direction and angle of view of the virtual camera is changed, if and when the changing amount of the imaging range is less than the first predetermined amount, the determinant is not updated.

According to the fourth embodiment, as similar to the first embodiment, it is possible to reduce as much as possible a phenomenon that a screen flickers at an edge portion of the shadow.

A fifth embodiment is according to the first embodiment, wherein the calculating portion does not calculate the determinant if and when the changing amount of the imaging range of the virtual camera is less than the first predetermined amount and a changing amount of a direction of a light from a light source is less than a second predetermined amount. Not only the imaging range of the virtual camera but also the direction of the light from the light source can be taken into account. The direction of the light from the light source such as a directional light (infinite light) is changed.

According to the fifth embodiment, it is possible to decide whether the determinant is to be updated in accordance with the changing amount of the direction of the light from the light source in a case where the changing amount of the imaging range of the virtual camera is less than the first predetermined amount. In such a case, as similar to the first embodiment, it is possible to reduce a phenomenon that a screen flickers at an edge portion of the shadow as much as possible.

A sixth embodiment is according to the first embodiment, wherein the calculating portion does not calculate the determinant if and when the changing amount of the imaging range of the virtual camera is less than the first predetermined amount and a changing amount of an irradiating range of a light form a light source is less than a third predetermined amount. The changing amount of the irradiating range of the light from the light source can be also taken into account in addition to the imaging range of the virtual camera.

According to the sixth embodiment, it is possible to decide whether the determinant is to be updated in accordance with the changing amount of the irradiating range of the light from the light source in a case where the changing amount of the imaging range of the virtual camera is less than the first predetermined amount. In such a case, as similar to the first embodiment, it is possible to reduce as much as possible a phenomenon that a screen flickers at an edge portion of the shadow.

A seventh embodiment is according to the sixth embodiment, wherein the irradiating range is changed by changing at least one of a position of the light source, direction of the light from the light source and an expanse of the light from the light source. A light source such as a point light source, an area light source and a spotlight, for example, may be employed.

An eighth embodiment is an image processing apparatus, comprising a calculating portion that repeatedly calculates a determinant for producing a shadow map; a producing portion that produces a shadow map by using a determinant that is calculated by the calculating portion; a depicting portion that depicts an image that is viewed from a virtual camera by using the shadow map produced by the producing portion, wherein the calculating portion does not calculate the determinant if and when a changing amount of the imaging range of the virtual camera is less than a predetermined amount.

A ninth embodiment is an image processing system, comprising a calculating portion that repeatedly calculates a determinant for producing a shadow map; a producing portion that produces a shadow map by using a determinant that is calculated by the calculating portion; a depicting portion that depicts an image that is viewed from a virtual camera by using the shadow map produced by the producing portion, wherein the calculating portion does not calculate the determinant if and when a changing amount of the imaging range of the virtual camera is less than a predetermined amount.

A tenth embodiment is an image processing method by a computer, wherein the computer performs steps of (a) repeatedly calculating a determinant for producing a shadow map so as to save into a storage; (b) producing a shadow map by using the determinant that is calculated in the step (a); and (c) depicting an image that is viewed from a virtual camera by using the shadow map produced in the step (b), wherein the determinant is not calculated in the step (a) if and when a changing amount of the imaging range of the virtual camera is less than a predetermined amount.

According to the eighth to tenth embodiments, as well, as similar to the first embodiment, it is possible to reduce a phenomenon that a screen flickers at an edge portion of the shadow as much as possible.

The above described objects and other objects, features, aspects and advantages of the embodiments will become more apparent from the following detailed description when taken in conjunction with the accompanying drawings.

### BRIEF DESCRIPTION OF THE DRAWINGS

FIG. 1 is a block diagram showing non-limiting example electrical structure of an information processing apparatus according to an embodiment.

FIG. 2 is a view showing a non-limiting example scene produced in a virtual space and a non-limiting example shadow map for the scene.

FIG. 3 is a view showing a non-limiting example memory map of a RAM shown in FIG. 1.

FIG. 4 is a flowchart of a non-limiting example portion of a determinant updating process by a CPU shown in FIG. 1.

FIG. 5 is a flowchart of another non-limiting example portion of the determinant updating process by the CPU shown in FIG. 1, following FIG. 4.

FIG. 6 is a view showing another non-limiting example of a light source.

FIG. 7 is a flowchart of another non-limiting example portion of the determinant updating process by the CPU shown in FIG. 1, following FIG. 5.

### DETAILED DESCRIPTION OF NON-LIMITING EXAMPLE EMBODIMENTS

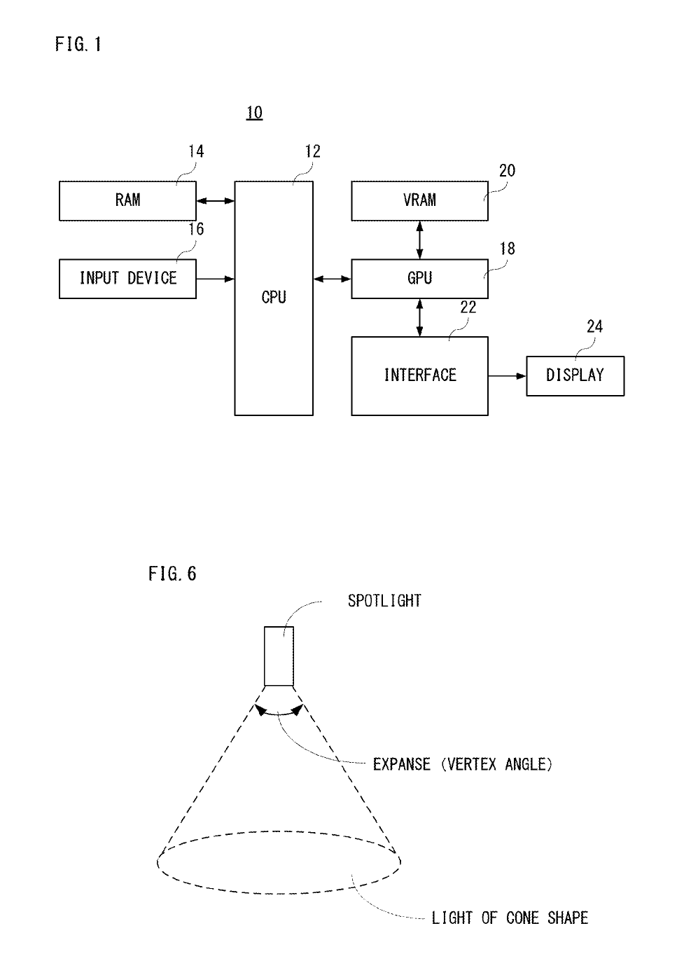

With referring to FIG. 1, an information processing apparatus 10 of this embodiment includes a CPU 12 to which a RAM 14, an input device 16 and a GPU 18 are connected. Furthermore, the GPU 18 is connected with a VRAM (video RAM) 20, and with a display 24 via an interface 22. As such an information processing apparatus 10, a general-purpose computer may be utilized.

The information processing apparatus 10 also functions as an image processing apparatus, and produces and outputs (displays) image data. Describing specifically, the GPU 18 models an object in a three-dimensional virtual space under instructions by the CPU 12. That is, a scene is produced within the virtual space. An image that the scene is imaged by a virtual camera, that is, an image that is viewed from a viewpoint is displayed on the display 24. A more specific process will be described. The scene produced in the virtual space is first converted into a coordinate system (camera coordinate system) that is captured from the virtual camera (perspective transformation). For example, an image that is viewed from a viewpoint is perspective-projected onto a virtual screen. Next, clipping processing and hidden-surface removal processing are applied. Subsequently, by applying a shading, a brightness (shade) of an object surface is represented. Furthermore, by applying a shadowing, a shadow that is produced by the object is represented. Then, a texture mapping is applied. A two-dimensional image is thus produced (depicted), two-dimensional image data corresponding to the two-dimensional image produced is output to the display 24 via the interface 22. In addition, the processing that two-dimensional image data is produced from three-dimensional data is called as “rendering”.

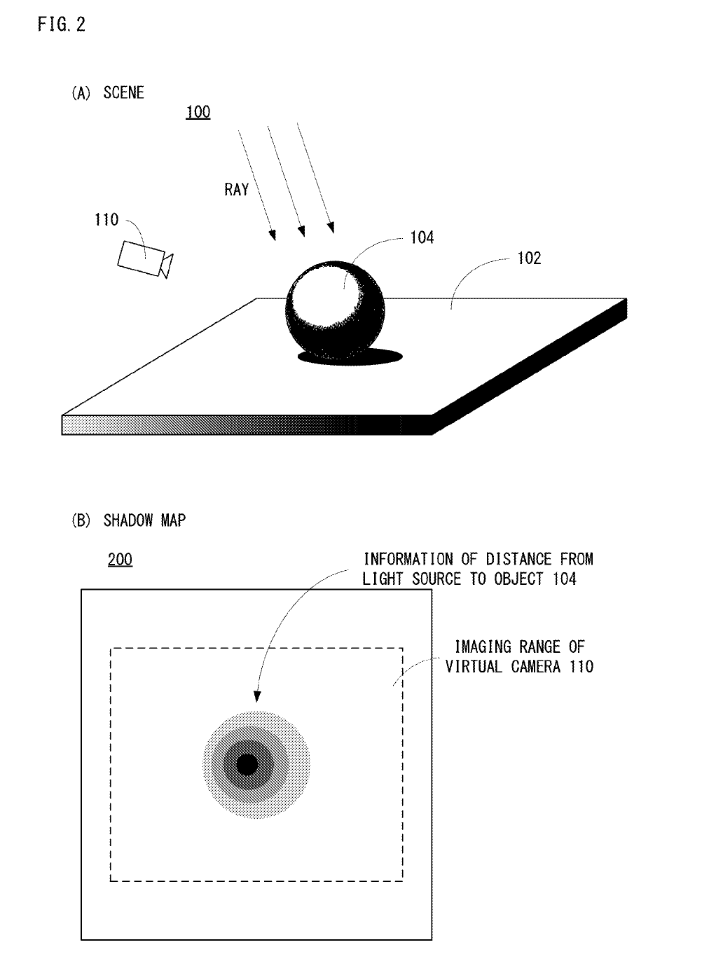

As shown in FIG. 2(A), for example, an object 102 and an object 104 are modeled in a virtual space. The object 102 is an object of a ground or floor, and the object 104 is an object of a sphere. As seen from FIG. 2(A), the object 104 is arranged on the object 102. Then, a light from a light source is irradiated to the object 102 and the object 104. In an example shown in FIG. 2(A), a directional light (infinite light) or a parallel light is irradiated from an upper left oblique side of the object 102 and the object 104. An image that the virtual camera 110 images such a scene 100 is displayed on the display 24 by applying the above-described processes.

In addition, the scene 100 shown in FIG. 2(A) is only an example, and not to be limited thereto. A kind of an object and the number of objects, for example, may be arbitrarily changed.

In this embodiment, a shadow map technique (depth buffer shadow technique) is applied to a calculation for shadowing. In the shadow map technique, information of a distance from a light source to an object (masking object) is utilized. Specifically, it is possible to obtain the information of the distance from the light source to the object by performing a Z buffer rendering that evaluates a depth value of the scene while a place (position) of the light source is regarded as a virtual viewpoint. The information of the distance from the light source to the object is stored in an internal image that is called as a shadow map (also called as depth map or shadow depth map). In addition, a resolution of the shadow map is decided in advance, and the information of the distance from the light source is stored for each pixel.

Furthermore, a producing process of a shadow map 200 is performed by the CPU 12 in parallel with a process for producing and outputting the above-described image data.

Then, in a case where the imaging range of the virtual camera 110 is rendered, for each pixel of the two-dimensional image that is produced, a distance (depth value) from the light source to the object in the virtual space is measured (calculated), and information of the distance (depth value) corresponding to each pixel is acquired from the shadow map. In a case where a depth value that is acquired is smaller than a depth value that is calculated, it is determined that no light is irradiated onto the pixel. That is, it is determined that the pixel is shadowed. On the other hand, in a case where a depth value that is acquired is coincident with a depth value that is calculated, it is determined that the pixel is exposed on the light.

In addition, in this embodiment, the directional light is irradiated and thus the light source is set at an infinite position, and therefore, the position of the light source that is assumed at a time that the shadow map is produced is evaluated through a calculation such that the shadow map that is produced (rendered) covers the imaging range of the virtual camera 110.

In FIG. 2(B), an example of an image (texture image) of a shadow map 200 that is produced for the scene 100 shown in FIG. 2(A) is shown. In the shadow map 200, the information of distance is represented by a monochrome, and the nearer distance from the light source, the lower (darker) brightness of the pixel. Furthermore, a size (range) of the shadow map 200 is set to be larger than the imaging range of the virtual camera 110 as shown in FIG. 2(B). The size of the shadow map 200 may be set in advance or calculated in accordance with the imaging range of the virtual camera 110.

A reason why the size of the shadow map 200 is thus made larger than the imaging range of the virtual camera 110 is that even in a case where the imaging range of the virtual camera 110 is changed, a determinant for rendering the shadow map 200 is prevented from being re-calculated (updated) when a changing amount of the imaging range is less than a predetermined amount. That is, it is intended that in a case where the imaging range of the virtual camera 110 is slightly changed, a shadow for the imaging range being changed can be represented (depicted) even if and when the determinant is not updated.

A reason of this is that if and when the determinant for rendering the shadow map 200 is re-calculated, that is, if and when a range that a shadow map 200 is to be produced is updated at every time that the imaging range of the virtual camera 110 is changed a little, there is an occasion that a subtle change occurs in a shape of an edge portion of the shadow and thus a screen flickers at that edge portion.

In addition, the imaging range of the virtual camera 110 is changed when the position, direction and angle of view of the virtual camera 110 are changed. Therefore, in fact, a determination on whether a changing amount of the imaging range of the virtual camera 110 is less than a predetermined amount is performed as follow. It is determined whether a changing amount of the position (a moving distance) of the virtual camera 110 is less than a first predetermined distance, and it is determined whether a changing amount of the direction (angle change) of the virtual camera 110 is less than a first predetermined angle, and it is further determined whether a changing amount of the angle of view (angle change) of the virtual camera 110 is less than a second predetermined angle. In addition, the changing amount is a cumulative value of the changing amount after the determinant is calculated (updated) previously. A reason of this is that if and when the determinant for producing the shadow map 200 is not updated in a case where the changing amount of the imaging range of the virtual camera 110 that is detected at every time that the image being displayed on the display 24 is updated, even though the imaging range of the virtual camera 110 is largely changed after the determinant is previously updated, the range that the shadow map 200 is produced is not changed, and thus, the shadow cannot be correctly represented (depicted).

The position, direction and angle of view of the virtual camera 110 are changed by operating the input device 16 by the user, for example. More specifically, if and when it is instructed that a screen is to be scrolled in the vertical direction or the horizontal direction, the position of the virtual camera 110 is changed. In addition, since the virtual camera 110 (viewpoint) is provided within the three-dimensional virtual space, the virtual camera 110 is movable in a depth direction or an oblique direction. If and when it is instructed that the virtual camera 110 is to perform panning, tilting or rolling, the direction of the virtual camera 110 is changed. Furthermore, if and when it is instructed that the virtual camera 110 is to perform zoom-in or zoom-out, the angle of view of the virtual camera 110 is changed.

These are mere examples, and in the information processing apparatus 10 such as a game apparatus, the virtual camera 110 follows the player character, and therefore, the position of the virtual camera 110 is changed in accordance with the movement of the player character. Furthermore, in a case where the player character looks into binoculars in the virtual space and an image viewed through the binoculars is to be displayed on the display 24, for example, by changing a direction of the binoculars or by changing a power of the binoculars, the direction or the angle of view of the virtual camera 110 is changed.

In addition, a position, direction and angle of view of the virtual camera 110 may be automatically changed in accordance with a program (information processing program) not by an operation by the user.

In addition, in this embodiment, it is possible to automatically change a direction of a light (angle of light) from the light source in accordance with a program (information processing program). The direction of the light from the light source can be changed such that the sun is moved according to a change of time within the virtual space, for example. Therefore, even in a case where the position, direction and angle of view of the virtual camera 110 are not changed, if and when a changing amount of the direction of the light from the light source (a change in the angle of ray) is equal to or more than a predetermined amount (a third predetermined angle), the determinant for producing the shadow map 200 is to be updated. In other words, in a case where a changing amount of the imaging range of the virtual camera 110 is less than the predetermined amount and the changing amount of the direction of the light from the light source is less than the predetermined amount, it is not necessary to update the determinant for producing the shadow map 200.

In addition, although a detailed description is omitted here, the first predetermined distance, the first predetermined angle, the second predetermined angle and the third predetermined angle are values that are empirically obtained by developers and programmers through simulations or the like, respectively. Threshold values such as the first predetermined distance, the first predetermined angle, the second predetermined angle and the third predetermined angle, for example are decided at a degree that no uncomfortable feeling is given in the image to be displayed even if and when the determinant for producing the shadow map 200 is not updated. This is true for following cases that threshold values are to be decided. In addition, as for the first predetermined angle, different values may be set for the panning, the tilting and the rolling, respectively, but the same value may be set.

In addition, the above-described respective threshold values may be dynamically changed in accordance with a history of an operation input by the user. In a case where an operation for changing the imaging range of the virtual camera 110 is frequently performed, for example, the respective threshold values are made larger, and in contrast, in a case where an operation for changing the imaging range of the virtual camera 110 is operated very few, for example, the respective threshold values may be made smaller. In addition, in a case where the imaging range of the virtual camera 110 is changed but the change is constant, the threshold values may be made smaller. The case where the change of the imaging range is constant means a case where a moving direction of the imaging range is a fixed direction or a case where the imaging range is continuously expanded or reduced. It is because in such a case, the user would not mind a flicker of the screen so much.

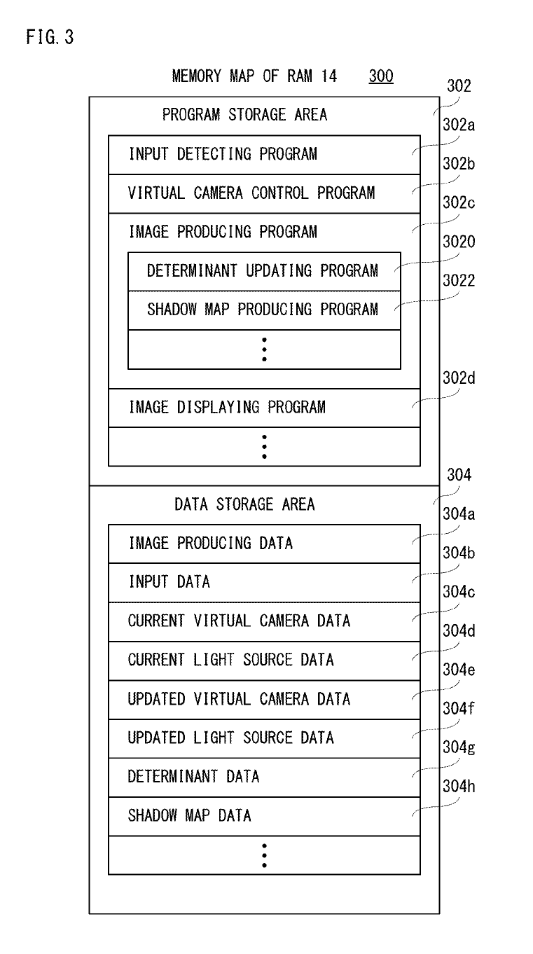

FIG. 3 shows an example of a memory map 300 of the RAM 14 shown in FIG. 1. As shown in FIG. 3, the RAM 14 includes a program storage area 302 and a data storage area 304. The program storage area 302 is stored with an information processing program that includes an input detecting program 302a, a virtual camera control program 302b, an image producing program 302c, an image displaying program 302d, etc. In addition, there is an occasion that the image producing 302c is called as an image processing program, or the image producing program 302c and the image displaying program 302d are collectively called as an image processing program.

Although a detailed description is omitted here, the information processing program can be stored in the RAM 14 by reading the same from an external storage medium that is attachable to or detachable from the information processing apparatus 10, or by downloading the same from an external computer. An SD card, CD or DVD and so on come within the external storage medium. Furthermore, the information processing program may be stored in advance in a non-volatile memory (not shown) of the information processing apparatus 10 and read from the non-volatile memory so as to be stored in the RAM 14.

The input detecting program 302a is a program for detecting input data from the input device 16. The CPU 12 acquires the input data from the input device 16 and stores the same in the RAM 14, in accordance with the input detecting program 302a. The virtual camera control program 302b is a program for controlling in accordance with instructions by the user or automatically the position, direction and angle of view of the virtual camera 110.

The image producing program 302c is a program for producing image data by using polygon data, texture data, etc. The image producing program 302c includes a determinant updating program 3020, a shadow map producing program 3022, etc. The determinant updating program 3020 is a program for determining whether the determinant for producing the shadow map 200 is to be calculated (updated), and for calculating (updating) the determinant if and when an when it is determined that the determinant is to be updated. As described above, the determinant is evaluated such that a depth value of the scene 100 viewed from the light source is rendered. The shadow map producing program 3022 is a program for producing the shadow map 200 for the scene 100 by using the determinant that is calculated in accordance with the determinant updating program 3020.

In addition, although not shown, the image producing program 302c is included with a program for modeling the object in the virtual space, a program for converting into a camera coordinate system, a program for performing a clipping and a hidden surface removal, a program for shading, a program for shadowing, a program for texture mapping, etc.

An image displaying program 302d is a program for displaying on the display 24 the image data that is produced in accordance with the image producing program 302c.

In addition, although not shown, the program storage area 302 is further stored with other programs necessary for the information processing.

In addition, the data storage area 304 is stored with image producing data 304a, input data 304b, current virtual camera data 304c, current light source data 304d, updated virtual camera data 304e, updated light source data 304f, determinant data 304g, shadow map data 304h, etc.

The image producing data 304a is the above-described polygon data, texture data and so on. The input data 304b is input data from the input device 16 in accordance with an operation by the user.

The current virtual camera data 304c is data about a position (three-dimensional position), direction and angle of view of the virtual camera 110 at present. The current light source data 304d is data about a direction of the light from the light source at present.

The updated virtual camera data 304e is data about the position (three-dimensional position), direction and angle of view of the virtual camera 110 at a time that the determinant for producing the shadow map 200 is previously calculated (updated). Therefore, until the determinant is updated next, the updated virtual camera data 304e is not updated. This is true for the updated light source data 304f.

The updated light source data 304f is data about the direction of the light from the light source at a time that the determinant for producing the shadow map 200 is previously calculated (updated).

The determinant data 304g is data about the determinant for producing the shadow map 200 (shadow map data 304h). The determinant is calculated (updated) in accordance with the above-described determinant updating program 3020. The shadow map data 304h is data about the shadow map 200 that is produced in accordance with the shadow map producing program 3022.

Although not shown, in the data storage area 304, other data are stored, and flags and counters (timers) are provided.

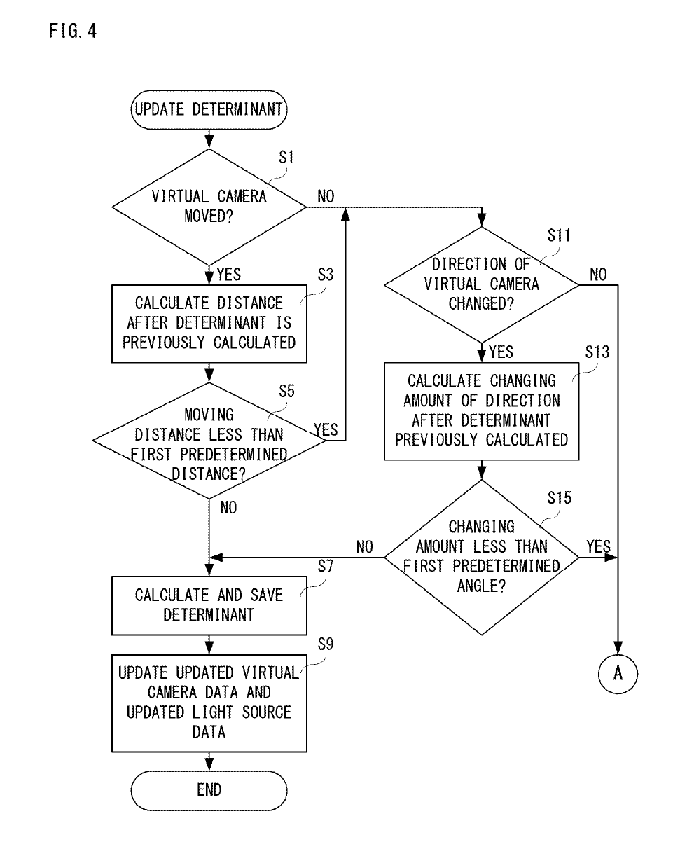

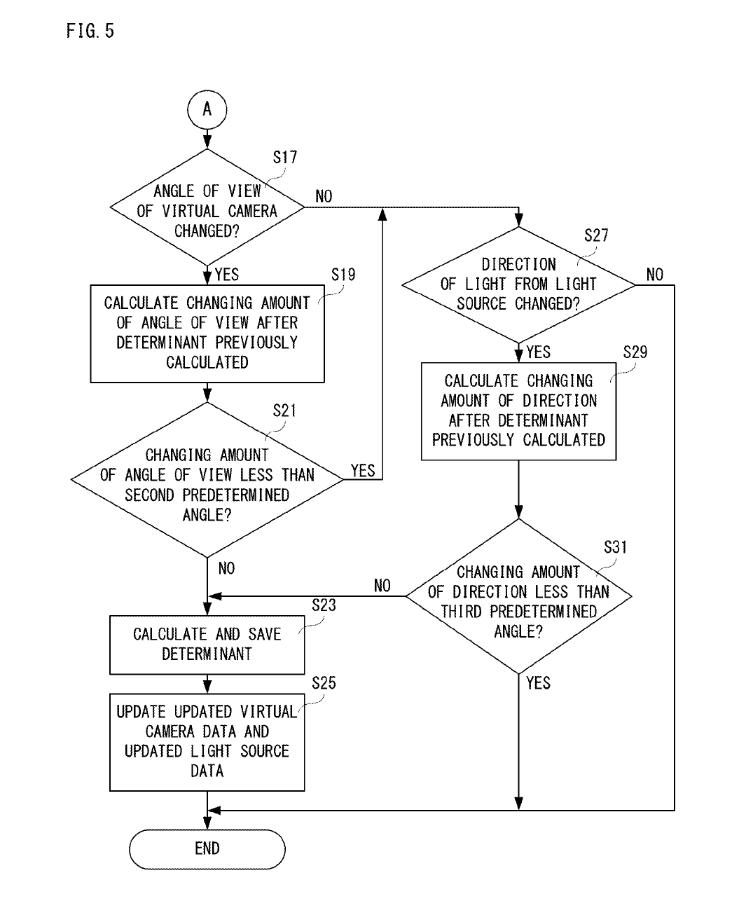

FIG. 4 and FIG. 5 show a flowchart showing a determinant updating process by the CPU 12 shown in FIG. 1. The determinant updating process is performed at every time that the production and display processing (not shown) for the image data are performed in parallel with the production and display processing of the image data.

In the production and display processing of the image data, by operating the input device 16 by the user, or in an automatic manner according to the program, the position, direction and angle of view of the virtual camera 110 are changed. That is, the current virtual camera data 304c is updated. Therefore, in the production and display processing of the image data, an operating input by the user (the input data from the input device 16) is detected. Furthermore, in the production and display processing of the image data, the direction of the light from the light source (angle of ray) is automatically changed in accordance with the program. That is, the current light source data 304d is updated. Furthermore, in the production and display processing of the image data, the shadow map data 304h is produced (updated).

Furthermore, since the production and display processing of the image data is performed for each frame, for example, the determinant updating process is also repeatedly performed for each frame. In addition, the frame is a unit time for updating the screen, and one frame is 1/60 seconds, for example. Furthermore, at a time that the production and display processing of the image data are firstly performed, initial values of the position, direction and angle of view of the virtual camera 110 (current virtual camera data 304c) are set and an initial value of the direction of the light source (current light source data 304d) is set.

As shown in FIG. 4, when the determinant updating process is started, the CPU 12 determines, in a step S1, whether the virtual camera 110 is moved. Here, the CPU 12 determines whether the position of the virtual camera 110 (three-dimensional position) is changed in the production and display processing of the image data.

If and when “NO” is determined in the step S1, that is, if the virtual camera 110 is not moved, the process proceeds to a step S11. On the other hand, if and when “YES” is determined in the step S1, that is, if and when the virtual camera 110 is moved, in a step S3, a moving distance after the determinant is previously calculated is calculated. Here, the CPU 12 calculates a difference between a current position of the virtual camera 110 shown by the current virtual camera data 304c and a position of the virtual camera 110 at a time that the determinant is previously calculated shown by the updated virtual camera data 304e, that is, the moving distance.

Subsequently, in a step S5, it is determined whether the moving distance is less than a first predetermined distance. If and when “YES” is determined in the step S5, that is, if and when the moving distance is less than the first predetermined distance, the process proceeds to the step S11. On the other hand, if and when “NO” is determined in the step S5, that is, if and when the moving distance is equal to or more than the first predetermined distance, in a step S7, the determinant is calculated and then stored. More specifically, a determinant for producing the shadow map 200 for a current scene 100 is calculated and the determinant data 304g corresponding to the determinant that is calculated is stored (over-written) in the data storage area 304. Then, in a step S9, the updated virtual camera data 304e and the updated light source data 304f are updated, and then, the determinant updating process is terminated. More specifically, in the step S9, the position, direction and angle of view of the virtual camera 110 at a time that the determinant for producing the shadow map 200 is updated are updated, and the direction of the light from the light source at a time that the determinant for producing the shadow map 200 is updated is updated.

Furthermore, in the step S11, it is determined whether the direction of the virtual camera 110 is changed. Here, the CPU 12 determines whether the panning, tilting or rolling of the virtual camera 110 is performed in the production and display processing of the image data. If and when “NO” is determined in the step S11, that is, if the direction of the virtual camera 110 is not changed, the process proceeds to a step S17 shown in FIG. 5. On the other hand, if and when “YES” is determined in the step S11, that is, if and when the direction of the virtual camera 110 is changed, in a step S13, a changing amount of the direction after the determinant is previously calculated is calculated. Here, the CPU 12 calculates an angle (difference) that is changed by the panning, tilting or rolling through comparison of a current direction of the virtual camera 110 shown by the current virtual camera data 304c with a direction of the virtual camera 110 at a time that the determinant is previously calculated shown by the updated virtual camera data 304e.

Then, in a step S15, it is determined whether the changing amount of the direction of the virtual camera 110 is less than a first predetermined angle. If and when “NO” is determined in the step S15, that is, if and when the changing amount of the direction of the virtual camera 110 is equal to or more than the first predetermined angle, the process proceeds to the step S7. On the other hand, if and when “YES” is determined in the step S15, that is, if and when the changing amount of the direction of the virtual camera 110 is less than the first predetermined angle, the process proceeds to the step S17 shown in FIG. 5.

As shown in FIG. 5, in the step S17, it is determined whether the angle of view of the virtual camera 110 is changed. Here, the CPU 12 determines whether the angle of view of the virtual camera 110 is changed in the production and display processing of the image data. If and when “NO” is determined in the step S17, that is, if the angle of view of the virtual camera 110 is not changed, the process proceeds to a step S27. On the other hand, if and when “YES” is determined in the step S17, that is, if and when the angle of view of the virtual camera 110 is changed, in a step S19, a changing amount of the angle of view after the determinant is previously calculated is calculated. Here, the CPU 12 calculates, by referring to the virtual camera data 304c, a difference between the current angle of view of the virtual camera 110 shown by the current virtual camera data 304c and an angle of view of the virtual camera 110 at a time that the determinant is previously calculated shown by the updated virtual camera data 304e, that is, a change of angle.

Then, in a step S21, it is determined whether the changing amount of the angle of view of the virtual camera 110 is less than a second predetermined angle. If and when “YES” is determined in the step S21, that is, if and when the changing amount of the angle of view of the virtual camera 110 is less than the second predetermined angle, the process proceeds to the step S27. On the other hand, if and when “NO” is determined in the step S21, that is, if and when the changing amount of the angle of view of the virtual camera 110 is equal to or more than the second predetermined angle, the determinant is calculated and then stored in a step S23, and the updated virtual camera data 304e and the updated light source data 304f are updated in a step S25, and then, the determinant updating process is terminated.

In addition, the processing in the step S23 is the same as the processing in the step S7 and the processing in the step S25 is the same as the processing in the step S9.

Furthermore, in the step S27, it is determined whether the direction of the light from the light source is changed. Here, the CPU 12 determines whether the direction of the light from the light source is changed in the production and display processing of the image data. If and when “NO” is determined in the step S27, that is, if the direction of the light from the light source is not changed, the determinant updating process is terminated with no operation. On the other hand, if and when “YES” is determined in the step S27, that is, if and when the direction of the light from the light source is changed, in a step S29, a changing amount of the direction of the light from the light source after the determinant is previously calculated is calculated. Here, the CPU 12 calculates a difference (change of angle) between the current direction of the light source (angle of ray) shown by the current light source data 304d and the angle of ray at a time that the determinant is previously calculated shown by the updated light source data 304f.

Then, in a step S31, it is determined whether the changing amount of the direction of the light from the light source is less than a third predetermined angle. If and when “NO” is determined in the step S31, that is, if and when the changing amount of the direction of the light from the light source is equal to or more than a third predetermined angle, the process proceeds to the step S23. On the other hand, if and when “YES” is determined in the step S31, that is, if and when the changing amount of the direction of the light from the light source is less than the third predetermined angle, the determinant updating process is terminated with no operation.

According to this embodiment, even in a case where the imaging range of the virtual camera and the direction of the light from the light source are changed, if and when the changing amount does not reach the predetermined amount, the determinant for producing a shadow map is not updated, and therefore, it is possible to reduce a flicker of the screen at an edge portion of the shadow as much as possible.

Furthermore, in this embodiment, since the number of times that the shadow map is updated is decreased, a processing load of the CPU can be reduced.

Although a case that the direction of the light from the light source is changed in this embodiment is described, the direction of light may be fixed. In such a case, it is not necessary to calculate the determinant according to the direction of the light from the light source. Therefore, the steps S27, S29 and S31 shown in FIG. 5 may be deleted, and in a case where “NO” is determined in the step S17 or “YES” is determined in the step S21, the determinant updating process may be terminated with no operation. That is, if and when the changing amount of the imaging range of the virtual camera is less than the predetermined amount, the determinant is not calculated (updated).

Although in this embodiment, a light source irradiating a directional light (infinite light) is provided at an infinite position, another light source may be set. A light source such as a point light source, an area light source and a spotlight, for example, may be arranged.

In a case where the point light source, the area light source or the spotlight is provided, since a range that a light or ray is irradiated, that is, an irradiating range is changed as different from the directional light, the determinant is not updated in a case where a changing amount of the irradiating range is less than a predetermined amount. It should be noted that a changing amount of the imaging range of the virtual camera is less than the predetermined amount. The irradiating range is changed in accordance with at least one of a position, direction and expanse of the light source.

In a case where the point light source is arranged, for example, the determinant is not updated if and when changing amounts of a position thereof are less than predetermined amounts. It is because, since the point light source irradiates a light on an upper, lower and side surfaces (all-direction), but a range that the light reaches is decided based on the attenuation of the light, and therefore, the irradiating range of the light is decided by the position of the point light source.

Furthermore, in a case where the area light source is provided, for example, if and when changing amounts of a position and a direction thereof are less than predetermined amounts, the determinant is not updated. It is because, since the area light source irradiates a rectangular light from a rectangular surface, the irradiating range of the light is decided by the position and the direction of the area light source.

Furthermore, in a case where the spotlight is arranged, for example, the determinant is not updated if and when changing amounts of a position, direction and expanse thereof are less than predetermined amounts. It is because, since the spotlight irradiates a corn-shape light, and the irradiating range of the light is decided by the position, direction and vertex angle (expanse) thereof.

In addition, the predetermined amounts in a case where the point light source, area light source or spotlight is arranged can be appropriately set through simulation by programmers or developers.

Furthermore, in a case where a plurality of light sources are arranged, the determinant is not updated if and when a changing amounts of each irradiating range of each of the plurality of light sources is less than the predetermined amounts.

In FIG. 6, one example of the spotlight and the range that the light is irradiated from the spotlight are shown. The light (ray) from the spotlight is irradiated in a corn-shape, and the range that the light from the spotlight is irradiated is changed in accordance with changes of the position, direction and expanse (vertex angle of corn shape) of the spotlight.

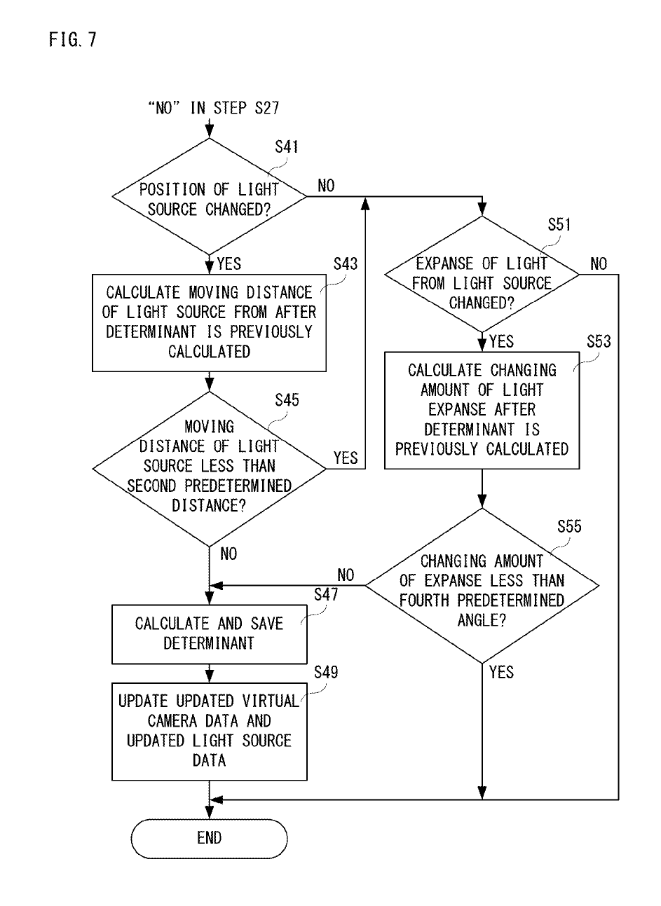

In a case where the spotlight, for example, is arranged instead of the light source that irradiates a directional light in the above-described embodiment, a part of the determinant updating process shown in FIG. 4 and FIG. 5 is changed. Briefly described, in a case where “NO” is determined in the step S27 in FIG. 5, a process according to a flowchart shown in FIG. 7 is performed.

In addition, in such a case, the current light source data 304d includes not only the data of the current direction of the light source but also the current position of the light source and the current expanse of the light from the light source (current vertex angle of a cone shape defining the irradiating range of the light). Similarly, the updated light source data 304f includes the data of the direction of the light source at a time that the determinant for producing the shadow map 200 is updated as well as the data of the updated position of the light source and the updated expanse of the light from the light source. Furthermore, in the production and display processing of the image data, not only the direction of the light from the light source (angle of ray) but also the position of the light source and the expanse of the light from the light source are automatically changed in accordance with the program.

As shown in FIG. 7, if and when “NO” is determined in the step S27, in a step S41, it is determined whether the position of the light source is changed. Here, the CPU 12 determines whether the position of the light source is changed in the production and display processing of the image data. If and when “NO” is determined in the step S41, that is, if the position of the light source is not changed, the process proceeds to a step S51. If and when “YES” is determined in the step S41, that is, if and when the position of the light source is changed, in a step S43, a moving distance of the light source after the determinant is previously updated is calculated. Here, the CPU 12 calculates a difference between the current position (three-dimensional position of the light source shown by the current light source data 304d) and the position of the light source at a time that the determinant is previously calculated shown by the updated light source data 304f.

Then, in a step S45, it is determined whether the moving distance of the light source is less than a second predetermined distance. If and when “YES” is determined in the step S45, that is, if and when the moving distance of the light source is less than the second predetermined distance, the process proceeds to the step S51. On the other hand, if and when “NO” is determined in the step S45, that is, if and when the moving distance of the light source is equal to or more than the second predetermined distance, the determinant is calculated in a step S47, and the updated virtual camera data 304e and the updated light source data 304f are updated in a step S49, and then, the determinant updating process is terminated.

In addition, the processing of the step S47 is the same as the processing of the step S7, and the processing of the step S49 is the same as the processing of the step S9. Furthermore, in a case where the spotlight is set, at a time that the updated light source data 304f is updated in the step S9, S25 and S49, not only the data of the direction of the light source but also the data of the position and the expanse are updated.

Furthermore, in the step S51, it is determined whether the expanse of the light from the light source is changed. Here, the CPU 12 determines whether the expanse of the light from the light source is changed in the production and display processing of the image data. That is, it is determined whether the vertex angle of the corn shape that defines the irradiating range of the light is changed.

If and when “NO” is determined in the step S51, that is, if the expanse of the light from the light source is not changed, the determinant updating process is terminated with no operation. On the other hand, if and when “YES” is determined in the step S51, that is, if and when the expanse of the light from the light source is changed, in a step S53, a changing amount of the expanse of the light after the determinant is previously calculated is calculated. Here, the CPU 12 calculates a difference (change of angle) between the vertex angle of the corn shape defining the irradiating range of the light from the light source shown by the current light source data 304d and the vertex angle of the corn shape defining the irradiating range of the light from the light source at a time that the determinant is previously calculated shown by the updated light source data 304f.

Then, in a step S55, it is determined whether the changing amount of the expanse of the light from the light source is less than a fourth predetermined angle. If and when “NO” is determined in the step S55, that is, if and when the changing amount of the expanse of the light from the light source is equal to or more than the fourth predetermined angle, the process proceeds to the step S47. On the other hand, if and when “YES” is determined in the step S55, that is, if and when the changing amount of the expanse of the light from the light source is less than the fourth predetermined angle, the determinant updating process is terminated with no operation.

In addition, although a detailed description is omitted here, the threshold values such as the second predetermined distance and the fourth predetermined angle are values that developers or programmers empirically acquires through simulation or the like as described above.

Furthermore, as described above, in a case where the point light source is set, in the determinant updating process shown by FIG. 4 and FIG. 5, instead of the steps S27, S29 and S31, the steps S41, S43 and S45 shown in FIG. 7 may be performed. In such a case, if and when “NO” is determined in the step S41 or “YES” is determined in the step S45, the determinant updating process is terminated, and if and when “NO” is determined in the step S45, the process proceeds to the step S23. In addition, the second predetermined distance is a value that is set in a case where the point light source is provided.

Furthermore, in the above-described embodiment, a case where a depth shadow technique is applied is described, but other techniques may be applied as far as the technique uses the shadow map. Specifically, it is possible to apply a perspective shadow map (PSM) technique, a light space perspective shadow map (LSPSM) technique, or a cascade LSPSM technique.

In addition, in a case where the PSM technique, the LSPSM technique or the cascade LSPSM technique is applied, the position of the light source is not calculated, the determinant for producing the shadow map (determinant for performing Z buffer rendering) is directly calculated from the imaging range of the virtual camera.

Furthermore, in this embodiment, it is determined that the distance and angle are less than the threshold values, but not limited thereto. It may be determined whether the distance and the angle are equal to or less than the threshold value.

Furthermore, the information processing apparatus may be constructed as an information processing system in that a plurality of computers each of which performs a portion of the process are connected with each other in a communication-capable manner.

The systems, devices and apparatuses described herein may include one or more processors, which may be located in one place or distributed in a variety of places communicating via one or more networks. Such processor(s) can, for example, use conventional 3D graphics transformations, virtual camera and other techniques to provide appropriate images for display. By way of example and without limitation, the processors can be any of: a processor that is part of or is a separate component co-located with the stationary display and which communicates remotely (e.g., wirelessly) with the movable display; or a processor that is part of or is a separate component co-located with the movable display and communicates remotely (e.g., wirelessly) with the stationary display or associated equipment; or a distributed processing arrangement some of which is contained within the movable display housing and some of which is co-located with the stationary display, the distributed portions communicating together via a connection such as a wireless or wired network; or a processor(s) located remotely (e.g., in the cloud) from both the stationary and movable displays and communicating with each of them via one or more network connections; or any combination or variation of the above.

The processors can be implemented using one or more general-purpose processors, one or more specialized graphics processors, or combinations of these. These may be supplemented by specifically-described ASICs (application specif and whenic integrated circuits) and/or logic circuitry. In the case of a distributed processor architecture of arrangement, appropriate data exchange and transmission protocols are used to provide low latency and maintain interactivity, as will be understood by those skilled in the art.

Similarly, program instructions, data and other information for implementing the systems and methods described herein may be stored in one or more on-board and/or removable memory devices. Multiple memory devices may be part of the same device or different devices, which are co-located or remotely located with respect to each other.

While certain example systems, methods, storage media, devices and apparatuses have been described herein, it is to be understood that the appended claims are not to be limited to the systems, methods, storage media, devices and apparatuses disclosed, but on the contrary, are intended to cover various modifications and equivalent arrangements included within the spirit and scope of the appended claims.

What is claimed is:

1. A non-transitory storage medium storing an image processing program that is executable by a computer, the image processing program causing the computer to function as;
a calculating portion that repeatedly calculates a determinant for producing a shadow map;
a producing portion that produces a shadow map by using a determinant that is calculated by the calculating portion; and
a depicting portion that depicts an image that is viewed from a virtual camera by using the shadow map produced by the producing portion, wherein
the calculating portion does not calculate the determinant if and when a changing amount of the imaging range of the virtual camera is less than a predetermined amount.

2. A non-transitory storage medium according to claim 1, wherein the changing amount of the imaging range is a cumulative changing amount after the determinant is previously calculated by the calculating portion.

3. A non-transitory storage medium according to claim 1, wherein the shadow map is produced for a range that is wider than the imaging range.

4. A non-transitory storage medium according to claim 1, wherein the imaging range is changed by changing at least one of a position, direction and angle of view of the virtual camera.

5. A non-transitory storage medium according to claim 1, wherein the calculating portion does not calculate the determinant if and when the changing amount of the imaging range of the virtual camera is less than the first predetermined amount and a changing amount of a direction of a light from a light source is less than a second predetermined amount.

6. A non-transitory storage medium according to claim 1, wherein the calculating portion does not calculate the determinant if and when the changing amount of the imaging range of the virtual camera is less than the first predetermined amount and a changing amount of an irradiating range of a light form a light source is less than a third predetermined amount.

7. A non-transitory storage medium according to claim 6, wherein the irradiating range is changed by changing at least one of a position of the light source, direction of the light from the light source and an expanse of the light from the light source.

8. An image processing apparatus, comprising:
a calculating portion that repeatedly calculates a determinant for producing a shadow map;
a producing portion that produces a shadow map by using a determinant that is calculated by the calculating portion; and
a depicting portion that depicts an image that is viewed from a virtual camera by using the shadow map produced by the producing portion, wherein
the calculating portion does not calculate the determinant if and when a changing amount of the imaging range of the virtual camera is less than a predetermined amount.

9. An image processing system, comprising:
a calculating portion that repeatedly calculates a determinant for producing a shadow map;
a producing portion that produces a shadow map by using a determinant that is calculated by the calculating portion; and
a depicting portion that depicts an image that is viewed from a virtual camera by using the shadow map produced by the producing portion, wherein
the calculating portion does not calculate the determinant if and when a changing amount of the imaging range of the virtual camera is less than a predetermined amount.

10. An image processing method by a computer, wherein the computer performs steps of:
(a) repeatedly calculating a determinant for producing a shadow map so as to save into a storage;
(b) producing a shadow map by using the determinant that is calculated in the step (a); and
(c) depicting an image that is viewed from a virtual camera by using the shadow map produced in the step (b), wherein
the determinant is not calculated in the step (a) if and when a changing amount of the imaging range of the virtual camera is less than a predetermined amount.
